(19) United States
(12) Patent Application Publication
(10) Pub. No.: US 2009/0299794 A1
(43) Pub. Date: Dec. 3, 2009

(54) Goods Distribution Management System

(76) Inventors: Alessandro Marchi, Milano (IT); Carla Maria Mezza, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/992,478

(22) PCT Filed: Sep. 30, 2005
(86) PCT No.: PCT/EP2005/054946

§ 371 Date: Aug. 19, 2009

(51) Int. Cl. G06Q 10/00; G06Q 30/00; G06N 5/02; G06Q 50/00

(52) U.S. Cl. 705/8; 705/26; 705/28; 706/47

(57) ABSTRACT

A goods distribution management system for managing the distribution of goods to a plurality of retailers including: a first goods distribution channel for distributing the goods to a first group of retailers; first and second goods distribution channels for distributing the goods to distinct groups of retailers; a first data processing system adapted to manage the distribution of goods in the first distribution channel, the first data processing system being adapted to manage orders of goods received from the retailers of the first group. The first data processing system includes: a first storage inquiry unit adapted to assess an availability of the ordered goods and a goods delivery schedule of the first distribution channel; a second storage inquiry unit adapted to assess an availability of the ordered goods in the goods storage of the at least one wholesaler; and a buy back request placement unit operatively associated with the first and second storage inquiry units and adapted to place a buy-back request to the at least one wholesaler for buying-back the ordered goods; the buy-back request, if accepted by the wholesaler, causes the wholesaler to schedule a delivery of the bought-back goods of the retailer of the first group.

### BACKGROUND OF THE INVENTION

1. Field of the Invention

The present invention relates to the field of the transport and distribution of goods, particularly relatively bulky goods like vehicle tires, from the production sites, or from large area distribution centers, to retail dealers.

2. Description of the Related Art

Efficiently managing the distribution of goods produced industrially in mass is a critical issue under many viewpoints.

Generally, starting from the production sites, the goods have to be transported to retail dealers, for being sold to the end customers. Typically, in their way from the production to the sale, the goods are routed through one or more intermediate distribution points. For example, the goods, initially stored in a storage of the manufacturing facility, are transported to one of several central distribution centers, corresponding to a specific, relatively wide geographic area. From the central distribution center, the goods may then be transported to one of several sub-distribution centers, each covering a smaller geographic region, and finally, possibly after passing through one or more other intermediate distribution centers, the goods are received at the retail dealers.

A distribution management system is for example disclosed in EP 1503320. The system includes an output terminal and a distribution management apparatus that manages distribution of items routed through distribution points in a predetermined order and transported to destinations, and determines, for each item delivery request, from which distribution point, items in stock should be allocated. The apparatus stores stock information indicating a quantity of currently and/or prospectively allocatable items, receives a delivery request, including a delivery time limit, to have specified items delivered, and judges whether an immediate delivery is indicated. The apparatus (i) if judged in the affirmative, selects the last distribution point before the destination as an allocation point when it has allocatable articles in stock, and (ii) if judged in the negative, selects a distribution point other than the last distribution point as the allocation point when it has allocatable articles in stock, and transmits information indicating the allocation point to the terminal.

### SUMMARY OF THE INVENTION

The Applicant has tackled the problem of devising an efficient goods distribution management system, particularly suited, albeit not limitatively, for the distribution of relatively bulky goods, like vehicle tires.

According to an aspect of the present invention, a goods distribution management system as set forth in appended claim 1 is provided, for managing the distribution of goods to a plurality of retailers.

The goods distribution management system comprises:
a first goods distribution channel for distributing the goods to a first group of retailers;
a second goods distribution channel for distributing the goods to a second group of retailers distinct from the retailers of the first group, wherein the second distribution channel includes at least one wholesaler having a goods storage including goods purchased from a goods manufacturer and distributing the purchased goods to the second group of retailers;
a first data processing system adapted to manage the distribution of goods in the first distribution channel, said first data processing system being adapted to manage orders of goods received from the retailers of the first group;

wherein said first data processing system includes:
a first storage inquiry unit adapted to assess an availability of the ordered goods and a goods delivery schedule of the first distribution channel;
a second storage inquiry unit adapted to assess an availability of the ordered goods in the goods storage of the at least one wholesaler, and
a buy-back request placement unit operatively associated with the first and second storage inquiry units and adapted to place a buy-back request to the at least one wholesaler for buying-back the ordered goods, said buy-back request, if accepted by the wholesaler, causing the wholesaler to schedule a delivery of the bought-back goods to the retailer of the first group.

According to another aspect of the present invention, a goods distribution management method as set forth in claim 8 is provided, for managing the distribution of goods to a plurality of retailers, comprising:
providing a first goods distribution channel for distributing the goods to a first group of retailers;
providing a second goods distribution channel for distributing the goods to a second group of retailers, distinct from the retailers of the first group, wherein the second distribution channel includes at least one wholesaler having a goods storage including goods purchased from a goods manufacturer and distributing the purchased goods to the second group of retailers;
receiving an order of goods from a retailer belonging to the first group of retailers, the order of goods including a delivery time constraint;
assessing an availability of the ordered goods and a goods delivery schedule of the first distribution channel,
in case the ordered goods are not available and/or the goods delivery schedule does not comply with the delivery time constraint:
retrieving information about the wholesaler goods storage;
assessing an availability of the ordered goods in the wholesaler goods storage;
in case of positive assessment of availability, placing a buy-back request to the at least one wholesaler for buying-back the ordered goods, wherein in case the buy-back request is accepted by the wholesaler, the wholesaler schedules a delivery of the bought-back goods to the retailer of the first group.

### BRIEF DESCRIPTION OF THE DRAWINGS

The features and advantages of the present invention will be made apparent by the following detailed description of some embodiments thereof, provided merely by way of non-limitative examples, description that will be carried out mailing reference to the attached drawings, wherein:

FIG. 1 pictorially shows a goods distribution management system according to an embodiment of the present invention, particularly for the distribution of vehicle tires;

FIG. 2 schematically shows, in terms of functional blocks, the main functional components of the goods distribution management system of FIG. 1, in an embodiment of the present invention;

FIG. 3 schematically shows a partial content of a database of a goods central storage of the goods distribution management system of FIG. 1, in an embodiment of the present invention;

FIG. 4 schematically shows a partial content of a database of a generic wholesaler of the goods distribution management system of FIG. 1, in an embodiment of the present invention;

FIG. 5 is a schematic flowchart of a goods distribution management method according to an embodiment of the present invention;

FIG. 6 pictorially shows an exemplary goods order placed by a generic retailer of the goods distribution management system of FIG. 1, in an embodiment of the present invention; and

FIG. 7 pictorially shows an exemplary goods buy-back order issued to a generic wholesaler of the goods distribution management system by the goods manufacturer, in an embodiment of the present invention.

### DETAILED DESCRIPTION OF THE PREFERRED EMBODIMENT(S)

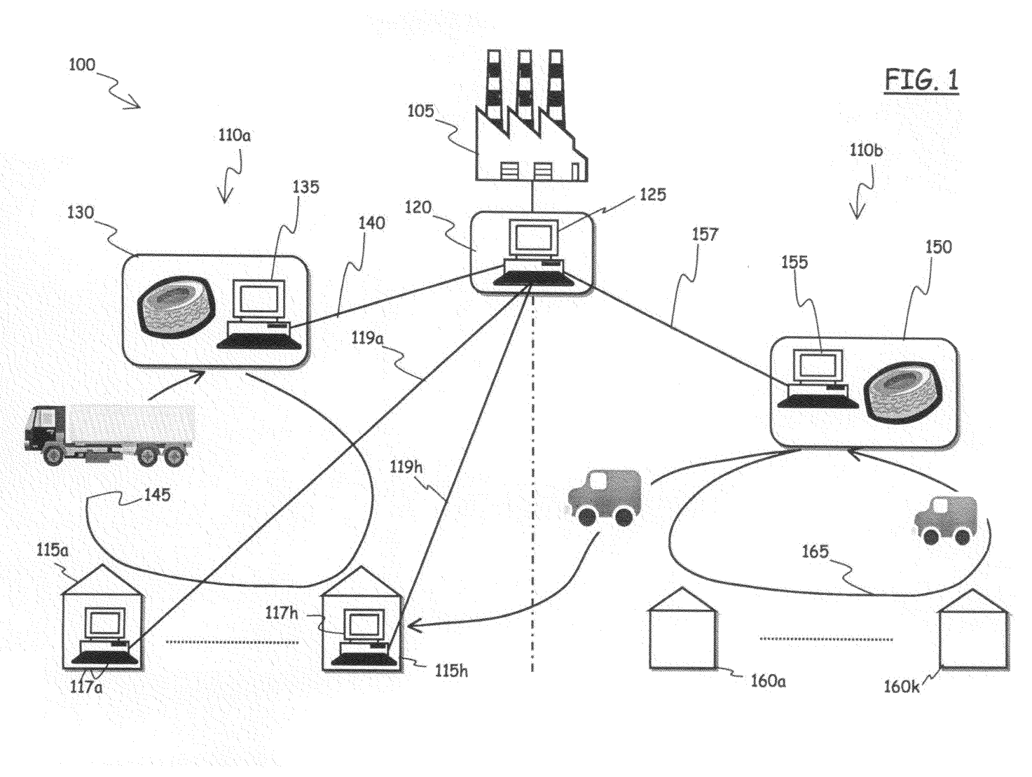

Making reference to FIG. 1, there is pictorially shown a goods distribution management system 100 according to an embodiment of the present invention, used by a goods manufacturing company 105 for the distribution of the produced goods from a goods manufacturing facility, or a large area goods distribution center (both of which are denoted by the same reference numeral 105), to retailers.

In particular, although not limitatively, the goods distribution management system 100 is a system for the distribution of vehicles tires.

The tire distribution management system 100 includes essentially two distribution channels 110a and 110b.

A first tire distribution channel 110a is a channel in which the distribution of the tires is essentially under the direct control of the tires manufacturing company 105: the tire manufacturer directly manages the distribution of the tires to a plurality of retailers 115a, . . . , 115h, which have a direct relationship with the manufacturing company 105.

For example, the tire distribution management system 100 includes a call center 120, set up by, or operating on behalf of the tire manufacturer, and provided with a data processing system 125 for the computerized management of the orders (receipt of orders, sale and delivery) of the tires from the retailers 115a, . . . , 115h of the first tire distribution channel 110a, as will be described in detail later.

The call center 120 interacts with one or more central tire storages 130 of the tire manufacturing company 105, wherein large stocks of possibly all the types of tires produced by the manufacturing company 105 are stored. Just by way of example, the central tire storage may handle some hundred thousands of tires per month.

The central tire storage 130 may be a facility owned by the tire manufacturer, or it can be owned by a third party, such as a logistic provider, offering services to the tire manufacturing company 105.

The central tire storage 130 may for example be provided with a data processing system 135 in data communications relationship, through a data communications link 140 (for example, via an open data communications network, like the Internet, or a dedicated channel, supporting for example an exchange of files in Electronic Data Interchange—EDI—format) with the data processing system 125 of the call center 120.

The retailers 115a, . . . , 115h may for example place orders to the call center either by phone or through a computerized system, in which case the retailers 115a, . . . , 115h have respective data processing systems 117a, . . . , 117h in data communications relationship, through data communications links 119a, . . . , 119h, with the data processing system 125 of the call center 120.

Reference numeral 145 in the drawing schematically identifies a first tire delivery system, belonging to the first tire distribution channel 110a, by which the ordered tires, taken from the central tire storages 130, are delivered to the retailers 115a, . . . , 115h. The first tire delivery system 145 includes in particular one or more relatively large trucks or other equivalent transportation means, which are used by the manufacturing company 105, or by the logistic provider running the central tire storage 130 and offering services to the tire manufacturing company, to satisfy the orders of the retailers 115a, . . . , 115h, delivering thereto the tires taken from the central tire storage 130.

The first tire delivery system 145 may operate on the basis of a relatively fixed time schedule, e.g. the orders coming from the different retailers 115a, . . . , 115h are collected at the call center 120 and, for example once a week, at the central tire storage 130 the truck(s) is loaded with tires corresponding to the collected orders and sent out to the retailers 115a, . . . , 115h for the delivery.

A second tires distribution channel 110b is instead not under the direct control of the tire manufacturing company 105: the tire manufacturing company 105 only interacts, for example through the call center 120, with one or more (typically, multi-brand) wholesalers, only one of which is depicted in FIG. 1 for simplicity, being identified by the reference numeral 150. Just by way of example, the generic wholesaler may handle some tens thousands of tires per month.

Reference numeral 155 identifies a data processing system of the generic wholesaler 150, which is for example used for the automated, computerized management of the wholesaler's tire stock, particularly for tracking the availability of the different possible articles in catalogue, taking account of the sales, and for scheduling when it is necessary to replenish the stock. The generic wholesaler 150 may place orders of tires to the tire manufacturing company 105, usually for large amounts of tires, for example through the call center 120; in particular, the orders may be placed in a computerized way, exploiting a data communications link 157 establishing a data communications relationship with the data processing system 125 of the call center 120. The data communications link 157 may be via an open data communications network, like the Internet, or via a dedicated channel, supporting for example an exchange of files in Electronic Data Interchange—EDI—format.

The generic wholesaler 150 supplies a relatively large number of retailers 160a, . . . , 160k, which are located in a more or less wide geographic area of competence of the wholesaler 150; differently from the retailers 115a, . . . , 115h, the retailers 160a, . . . , 160k do not have direct relationships with the tire manufacturing company 105.

The retailers 160a, . . . , 160k place orders to the wholesaler 150 (either by phone or through a computerized system, in which case the retailers 160a, . . . , 160k have respective data processing systems—not shown in the drawing—in data communications relationship with the data processing system 155 of the wholesaler 150).

Reference numeral 165 in the drawing schematically identifies a second tire delivery system, by which the tires ordered by the retailers 160a, . . . , 160k to the wholesaler 150, taken from the wholesaler's stock, are delivered to the retailers 160a, . . . , 160k. The second tire delivery system 165 may in particular include one or more relatively small vans, which are used by the wholesaler 150 to satisfy the orders of the retailers 160a, . . . , 160k. In particular, compared to the first tire delivery system 145, the second tire delivery system may have a more frequent time schedule, and is more flexible, suitable for satisfying extemporary tire orders from the retailers 160a, . . . , 160k. For example, while in the first tire delivery system one or two deliveries per week from the central tire storage to the retailers may be scheduled, in the second tire delivery system the deliveries from the wholesaler to the retailers may be as frequent as one or two per day.

The stocks of the retailers are substantially smaller compared to those of the central tire storage and of the wholesalers. For example, a retailer of the first distribution channel may handle some hundreds tires per month, whereas the generic retailer of the second distribution channel may handle some tens of tires per month.

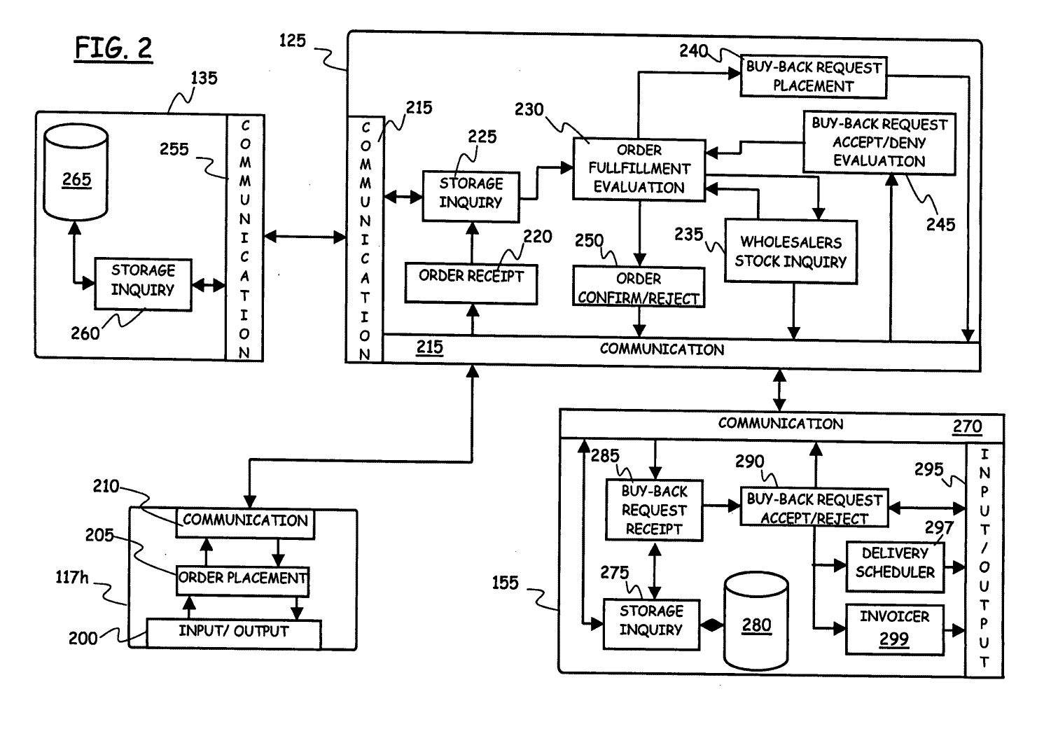

FIG. 2 schematically depicts, in terms of functional blocks, the main functional components of the tire distribution management system of FIG. 1, in an embodiment of the present invention. It is pointed out that the functions of the generic functional block may be implemented by software, by hardware, or by a mix of software and hardware; thus, the generic component in FIG. 2 may be a software component, a hardware component, or a mix of the two.

The data processing system 117a, . . . , 117h of the generic retailer 115a, . . . , 115h of the first tire distribution channel, e.g. the data processing system 117h of the retailer 115h, includes an input/output unit 200, through which a human operator interacts with the data processing system; in particular, the input/output unit may comprise a keyboard, a pointing device (like a mouse), a display device, a printer and so on. An order placement unit 205 allows the human operator, through the input/output unit 200, to compile and place an order for tires to the data processing system 125 of the call center 120 of the tire manufacturing company 105. A communication unit 210 handles communications with the data processing system 125 of the call center 120.

The data processing system 125 of the call center 120 includes a communication unit 215, for handling communications with the data processing systems 117a, . . . , 117h of the retailers 115a, . . . , 115h, with the data processing system 135 of the central tire storage 130, and with the data processing systems of the wholesalers, like the data processing system 155 of the wholesalers 150 in FIG. 1.

An order receipt unit 220 receives orders placed by the retailers 115a, . . . , 115h; in particular, and just by way of example, the data processing system 125 of the call center 120 may be programmed so as to be accessible by the data processing systems 117a, . . . , 117h of the retailers 115a, . . . , 115h through a dedicated access portal. The order receipt unit 220 interacts with a storage inquiry unit 225, adapted to get information suitable to establish the capability of fulfillment of the received order by the first tire distribution channel 110a; in particular, the storage inquiry unit 225 is adapted to perform an inquiry on the central tire storage 130 so as to ascertain the availability of the tires ordered by the generic retailer 115a, . . . , 115h, and the compliance with a time delivery constraint, as will be described in greater detail later on.

The storage inquiry unit 225 interacts with an order fulfillment evaluation unit 230, adapted to evaluate the capability of fulfillment of the received order.

According to an embodiment of the present invention, the order fulfillment evaluation unit 230 further interacts with a wholesalers stock inquiry unit 235, adapted to perform an inquiry about the availability of the tires ordered by the generic retailer 115a, . . . , 115h in the stocks of the wholesalers 150. A tire buy-back request placement unit 240 is adapted to place tire buy-back requests to the wholesalers 150, and a buy-back request accept/deny evaluation unit 245 is adapted to evaluate responses received from the wholesalers 150 about the tire buy-back requests placed thereto.

The order fulfillment evaluation unit 230 interacts with an order confirm/reject unit 250, adapted to issue to the proper retailers 115a, . . . , 115h confirmations or rejections of the orders they placed.

In the data processing system 135 of the central tire storage 130, a communication unit 255 manages communications with the data processing system 125 of the call center 120; a storage inquiry unit 260 interacts with a database 265 of the central storage 130, and is adapted to retrieve information about the availability, in the central tire storage 130, of the ordered tires, and about the delivery time schedule; the storage inquiry unit 260 is adapted to pass the retrieved information to the storage inquiry unit 225 of the data processing system 125 of the call center 120. Alternatively, a local copy of the database 265 of the central tire storage 130 may be held at the call center 120, and the storage inquiry unit 225 of the call center's data processing system 125 may perform queries on the local database copy, instead of accessing in real time the database 265 of the central tires storage 130; the local copy of the database 265 may be kept regularly updated, for example on a hourly or half-hourly basis.

In the data processing system 155 of the generic wholesaler 150, particularly a wholesaler having set up a service-level agreement with the tire manufacturing company 105, a communication unit 270 manages communications with the data processing system 125 of the call center 120. A storage inquiry unit 275 interacts with a database 280 of the wholesaler 150, and is adapted to retrieve information about the availability, in the stock of the wholesaler 155, of the tires, in response to inquiries from the wholesalers stock inquiry unit 235 in the data processing system 125 of the call center 120 of the tire manufacturing company 105. The storage inquiry unit 275 is adapted to pass the retrieved information to the wholesale stock inquiry unit 235 of the data processing system 125 of the call center 120. A buy-back request receipt unit 285 is adapted to receive tire buy-back requests issued from the buy-back request placement unit 240 in the data processing system 125 of the call center 120. The buy-back request receipt unit 285 interacts with a buy-back request acceptance confirmation/rejection unit 290, adapted to process the received buy-back request; for example, the received tire buy-back request may be displayed to a human operator at the wholesaler through an input/output unit 295 of the data processing system 155, and the human operator can make his/her decision and confirm or reject the tires buy-back request, through the input/output unit 295. The tire buy-back request confirm/reject unit 290 is adapted to issue a buy-back request acceptance or a buy-back order request rejection, which is received by the buy-back request accept/deny evaluator unit 245. The buy-back request confirm/reject unit 290 also interacts with a delivery scheduler unit 297, adapted to schedule the delivery of the tires, in case the buy-back request is accepted, and with an invoicer unit 299, adapted to issue the invoice for the tires bought-back to the tire manufacturing company 105. Alternatively, a local copy of the database 280 of the wholesaler 150 may be held at the call center 120, and the storage inquiry unit 275 of the data processing system 125 may perform queries on the local database copy, instead of accessing in real time the database 280 of the wholesaler 150; the local copy of the wholesaler's database 280 may be kept regularly updated, for example on a hourly or half-hourly basis.

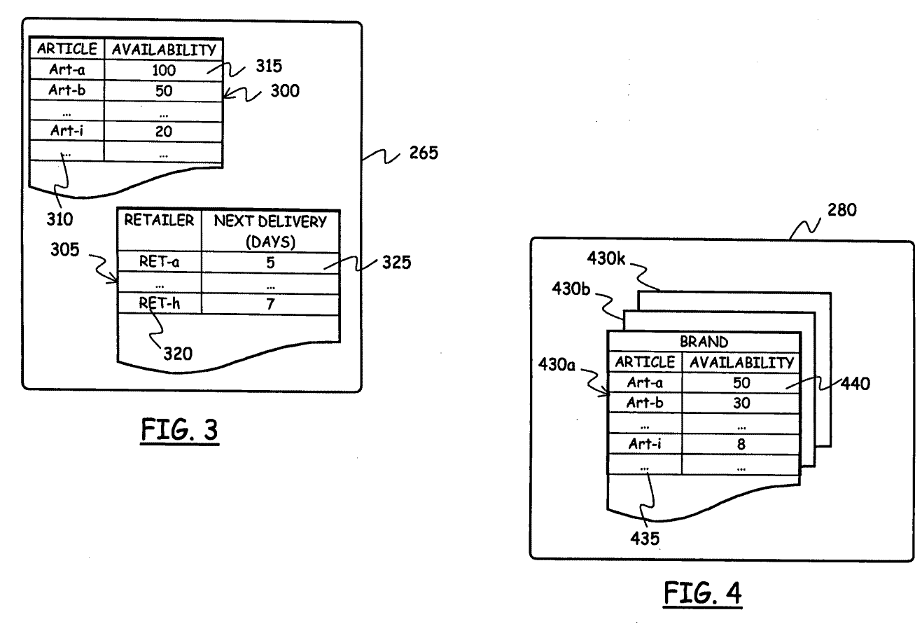

FIG. 3 shows schematically a partial content of the database 265 of the central storage 130. The database 265 includes a first collection of data 300 and a second collection of data 305. The first collection of data 300 includes a list 310 of all the articles, in the present example a list of all the tire models produced by the tire manufacturing company 105, and, for each tire model, an indication 315 of an availability of tires of such model in the central tire storage 130. The second collection of data 305 includes a list 320 of all the retailers 115a, . . . , 115h of the first tire distribution channel, and, for each retailer, an indication (or at least a forecast) 325 of when the next delivery is scheduled, e.g. in terms of number of days to go.

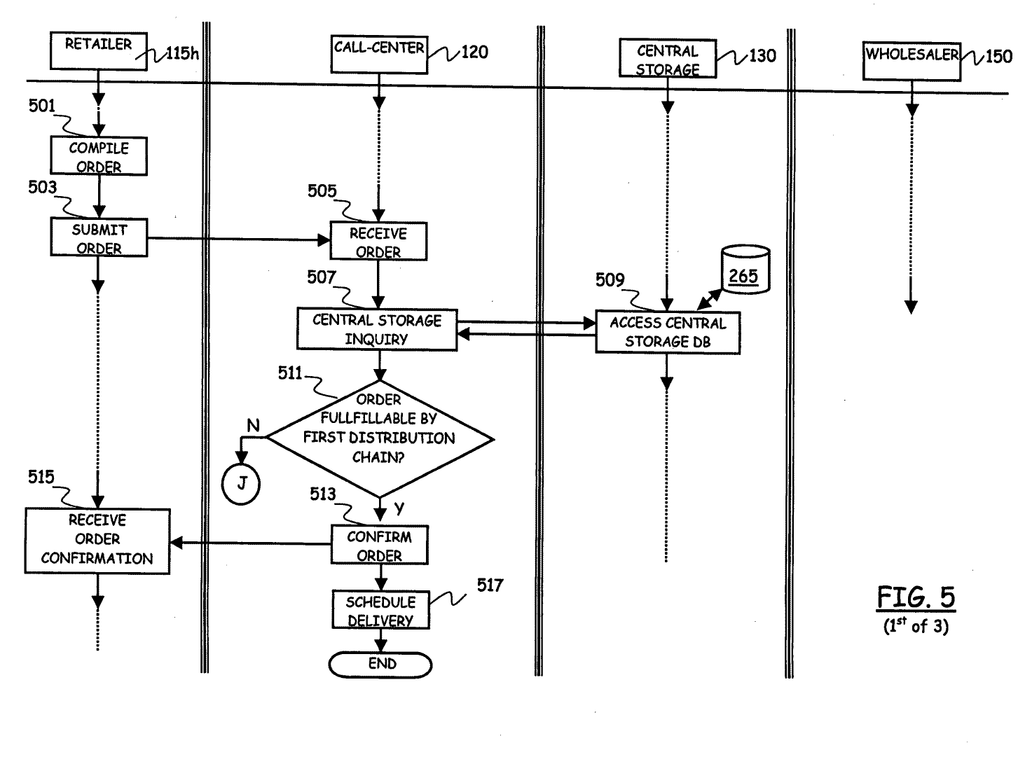

FIG. 4 similarly shows schematically a partial content of the database 280 of the generic wholesaler 150. The database includes a plurality of collections of data 430a, 430b, . . . , 430k, each one corresponding to a respective brand of tires distributed by that specific wholesaler 150, i.e. to a respective tire manufacturing company 105. Each collection of data 430a, 430b, . . . , 430k includes a list 435 of all the tire models of that brand in the catalog of the wholesaler 150, and, for each tire model, an indication 440 of a current availability of tires of such model in the stock of the wholesaler 150.

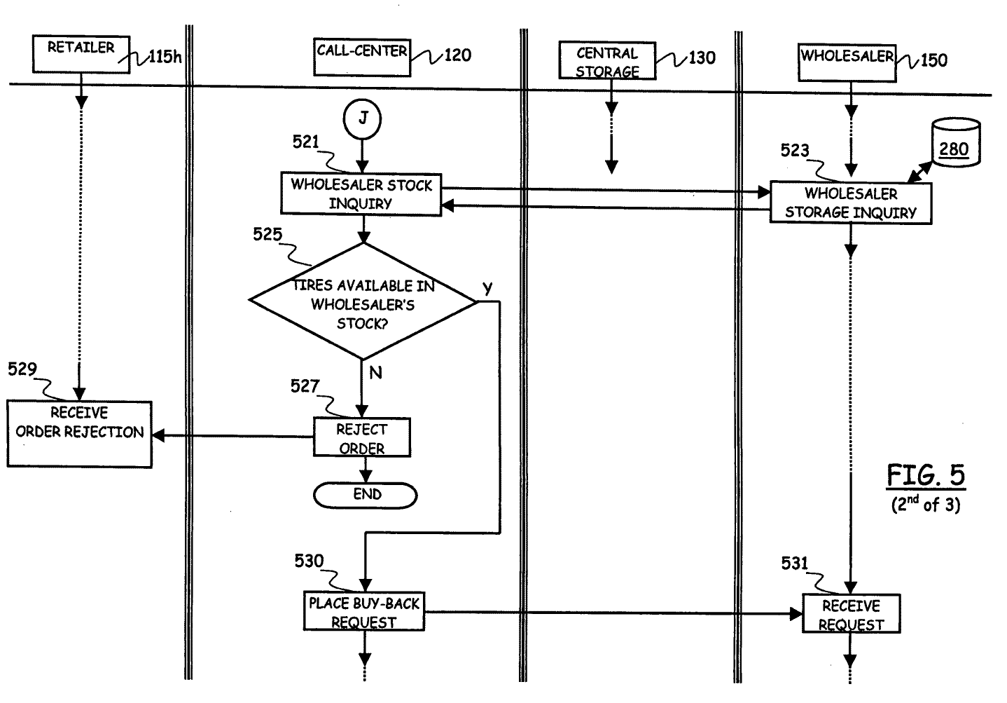

A tire distribution management method according to an embodiment of the present invention will be now described, with the help of the schematic, simplified operation flow chart of FIG. 5.

When a retailer 115a, . . . , 115h in the first tire distribution channel 110a, e.g. the retailer 115h, needs to purchase tires from the tire manufacturing company 105, he/she places a tire order to the call center 120. The order may be placed for example by phone, or using the retailer's data processing system 117a, . . . , 117h. In particular, the retailer 115h may compile the order through the data processing system's input/output unit 200 (block 501), and he/she causes the order to be submitted (by the order placement unit 205 and the communication unit 210) to the data processing system 125 of the call center 120 (block 503).

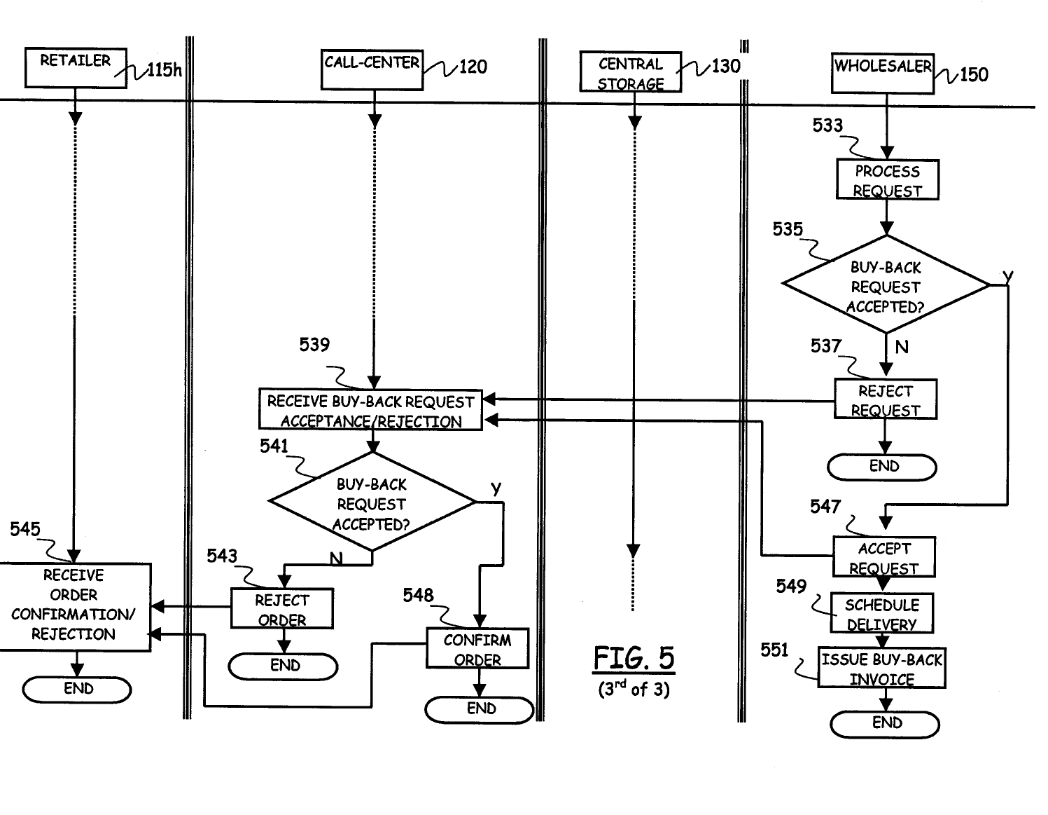

FIG. 6 pictorially shows an exemplary tire order 600 placed by a generic retailer (RET-a) to the call center 120. The tire order 600 is labeled with an identifier RET-a of the retailer that is placing the order, and includes a list 605 of tire models which that retailer wishes to purchase from the tire manufacturing company 105. For each ordered tire model in the list 605, an ordered amount of tires 610 is specified, together with an indication 615 (e.g., in number of days) of the desired delivery date. For example, a desired delivery date indication like “STANDARD” may indicate that the retailer has no particular time constraints, and that he/she accepts a delivery of the ordered tires according to the fixed delivery time schedule, which, as mentioned in the foregoing, may for example provide for one or two deliveries per week; this is for example suitable for regular retailer's stock replenishment.

However, the retailer has the possibility of specifying a different desired delivery time; this is for example the case when the standard delivery time is considered not suitable, for example because the retailer wishes to satisfy an extemporary, urgent request by a client of a particular model of tires that is not in the regular stock of the retailer (i.e., the stock of the most commonly sold tires models).

Coming back to FIG. 5, the (order receipt unit 220 of the) data processing system 125 of the call center 120 receives the tire order from the (data processing system of the) retailer 115h (block 505). The storage inquiry unit 225 in the data processing system 125 of the call center 120 contacts the storage inquiry unit 260 in the central tire storage 130 to get information about the capability of fulfilling the order (block 507).

In particular, the storage inquiry unit 225 gets from the database 265 information such as the availability, in the central tire storage 130, of tires of the requested model (for example, with reference to FIG. 3, the first collection of information 300 is accessed using the ordered tire model as an accession key, and the corresponding availability in the central tire storage is retrieved) and the scheduled (or forecast) delivery time for that retailer (for example, the second collection of information 305 is accessed using the retailer identifier as an accession key, and the associated scheduled (or forecast) delivery time is retrieved). Alternatively, in case a copy of the database 265 is held locally at the call center 120, the storage inquiry unit 225 retrieves the relevant information by performing a query on the local database copy.

The retrieved data are passed to the order fulfillment evaluation unit 230, which checks whether the received order can be fulfilled by the first tire distribution channel 110a (decision block 511). In particular, the order fulfillment evaluation unit 230 checks whether there is availability, in the central tire storage 130, of the requested amounts of the specific tire models listed in the received order 600 (in particular, for each article listed in the received order, the order fulfillment evaluation unit 230 performs the check: AVAILABILITY≧AMOUNT?); furthermore, the order fulfillment evaluation unit 230 checks whether the scheduled (or forecast) delivery time for that retailer meets the retailer's needs (in particular, the order fulfillment evaluation unit 230 performs the check: DESIRED DELIVERY≧NEXT DELIVERY?). In the affirmative case (exit branch Y of decision block 511), the order confirm/reject unit 250 sends to the retailer an order confirmation (block 513), which is received by the retailer (block 515), who can thus be confirmed that the ordered goods will be delivered thereto in the desired time. The data processing system 125 of the call center 120 also manages the scheduling of the delivery of the requested tires to the retailer, by instructing the central tire storage 130 to reserve the specified types and amounts of tires for the next delivery to the retailer 115h (block 517).

When, according to the fixed delivery time schedule, the scheduled delivery day comes, a truck is loaded with the tires ordered by the retailer 115h (as well as by other retailers 115a, . . . , 115h of the internal tires distribution channel), and sent out to deliver to the retailers 115a, . . . , 115h (or to groups of them) the ordered tires. The tires are thus delivered to the retailer through the first tire delivery system 145.

This may be expected to be the working of the distribution system in case the retailers 115a, . . . , 115h have to satisfy requests from their customers of the most commonly sold types of tires: in this case, each retailer 115a, . . . , 115h is in condition of keeping his/her stock adequately full, by placing regular orders to the tire manufacturer 105 based on the expected sales, and the delivery time schedule of the first delivery system, albeit not very frequent, results adequate.

Problems may arise when the generic retailer 115a, . . . , 115h wishes to satisfy a customer request involving tires that, albeit in catalogue, are relatively unusual (such as for example tires for particular vehicles, like luxury cars or sport cars): the retailers 115a, . . . , 115h typically do not have such a vast and differentiated stock, and in a case like this they may have to place a specific, extemporary order to the manufacturer. In this case, the time constraints that the retailer may have for satisfying the customer request may be such as not to allow to wait for the fixed schedule of the first tire distribution system. A possible solution might be to set up, in the first distribution channel, a dedicated delivery of those (and only those) specific tires, for that specific retailer. However, this is highly inefficient, because it may involve sending out a relatively big truck almost empty, loaded only with the specific goods requested by the customer, which is highly inefficient; alternatively, the tire manufacturer or the logistic provider running the central tire storage 130 should equip with a fleet of smaller trucks (and drivers) just for being ready to satisfy possible extemporary requests from the retailers; also this solution is regarded as being highly inefficient.

According to an embodiment of the present invention, if the order fulfillment evaluation unit 230 of the call center's data processing system 125 ascertains (exit branch N of decision block 511, connector J) that the received tire order cannot be fulfilled by the internal distribution channel 110a, for example because in the central tire storage 130 there is no availability of the requested amounts of one or more of the tire models listed in the received order 600 (i.e., AVAILABILITY<AMOUNT), or, which is more probable, the delivery time according to the fixed delivery time schedule for the first tire delivery system 145 does not meet the request of the retailer (i.e., DESIRED DELIVERY<NEXT DELIVERY), the data processing system 125 of the call center 120 checks whether it is possible to fulfill the order relying on the second tire distribution channel 110b.

In particular, the order fulfillment evaluation unit 230 invokes the wholesalers stock inquiry unit 235 so as to check the availability of the requested tires in the stock of the wholesalers (block 521).

The wholesalers stock inquiry unit 235 may for example operate on the basis of a list of wholesalers, available at the data processing system 125 of the call center, in which there is specified which ones, among all the possible wholesalers who purchase tires from the tire manufacturing company 105, have an agreement with the tire manufacturing company allowing the tire manufacturing company 105 to buy back tires already sold and delivered to the wholesaler. Also, the wholesalers stock inquiry unit 235 preferably performs the inquiry taking into account a geographical proximity criterion, so that wholesalers that are geographically nearer to the retailer 115h are inquired first.

Considering the generic wholesaler 150 in the list, the storage inquiry unit 275 in the respective data processing system 155 accesses the stock database 280 of the wholesaler (block 523). In particular, referring to FIG. 4, the storage inquiry unit 275 accesses the collection of data 330a relating to the tire manufacturing company 105. The storage inquiry unit 275 gets from the database 280 information such as the availability, in the wholesaler's stock, of tires of the requested model (for example, the collection of data 330a relating to the tire manufacturing company 105 is accessed using the tire model as an accession key, and the corresponding availability is retrieved). The retrieved data are passed back to the wholesalers stock inquiry unit 235: in this way, the call center 120 has a visibility of the wholesalers' stocks of tires produced by and which the wholesalers have purchased from the tire manufacturing company 105. Alternatively, in case a local copy of the (part of the) wholesaler database is held at the call center, the wholesalers stock inquiry unit 235 may retrieve the necessary information by performing a query on the local database copy, instead of real-time accessing the database 280.

If, based on the data retrieved by the wholesaler stock inquiry unit 235, the order fulfillment evaluation unit 230 ascertains that the wholesaler 150 does not have tires of the requested type available in its stock (decision block 525, exit branch N), the order fulfillment evaluation unit 230 instructs the order confirm/reject unit 250 to issue an order reject notification to the retailer 115h (block 527); the notification is received by the retailer 115h (block 529), which is thus informed of the impossibility of satisfying his/her request. Preferably, before issuing an order reject notification, the order fulfillment evaluation unit 230 inquires one or more other wholesalers in the list of those having accepted the agreement with the tire manufacturing company 105: if none of the wholesalers has tires of the requested type available in its stock, the order fulfillment evaluation unit 230 issues the order reject notification.

If instead the order fulfillment evaluation unit 230 ascertains that the wholesaler 150 has tires of the requested type available in its stock (decision block 525, exit branch Y), the order fulfillment evaluation unit 230, through the buy-back request placement unit 240, places a buy-back request of the specified tires (type and amount) to the wholesaler 150 (block 530); the buy-back request is received by the (buy-back request receipt unit 285 of the) data processing system 155 of the wholesaler 150 (block 531).

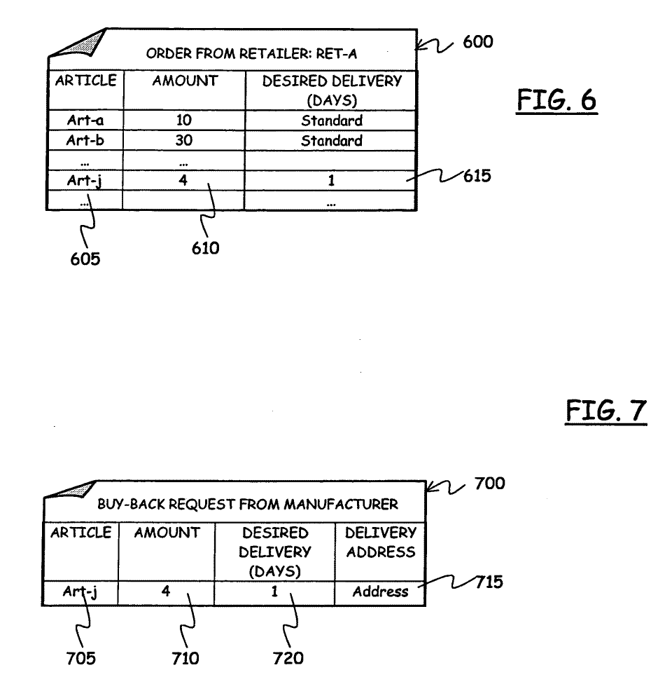

FIG. 7 schematically shows an exemplary buy-back request issued by the data processing system 125 of the call center 120 to a generic wholesaler 150 for buying back previously sold tires. The tires buy-back request 700 is labeled with an identifier of the tires manufacturing company 105, and includes a description 705 of the tires model that the tires manufacturing company 105 wishes to buy back from the wholesaler, together with a requested amount 710 of tires to be bought back, an indication 715 of the delivery location (i.e., the address of the retailer 115h), and an indication 720 (e.g. in number of days) of the desired delivery date.

At the wholesaler 150, the received buy-back request is processed (block 533); in particular, and by way of example, the buy-back request 700 is displayed (through the input/output unit 295) to a human operator at the wholesaler 150, which can thus make a decision about whether to accept or reject the buy-back request. In particular, the decision may depend on the fact that, also in view of the geographical location of the retailer 115h, the wholesaler cannot ensure the delivery in the requested time, and/or because the wholesaler has knowledge that the specified tires will be needed in short time, because they have already been requested by one of the retailers 160a, . . . , 160k, or the like.

If the buy-back request is rejected (decision block 535, exit branch N), the buy-back request accept/reject unit 290 notifies the buy-back request accept/deny evaluation unit 245 of the call center data processing system 125 (block 537).

Upon receipt of the buy-back request rejection (block 539 and decision block 541, exit branch N), one or more other wholesalers in the list of those having set-up the service-level agreement with the tire manufacturing company may be similarly inquired. If none of the wholesalers is available for satisfying the request, the order fulfillment evaluation unit 230 in turn notifies the retailer 115h that the order cannot be fulfilled (block 543). The order rejection is received by the retailer 115h (block 545).

If instead the wholesaler 150 decides to accept the buy-back request (decision block 535, exit branch Y), the buy back request accept/reject unit 290 positively notifies the buy-back request accept/deny evaluation unit 245 of the call center data processing system (block 547). The information included in the buy-back request sent by the call center are exploited by the wholesaler for transforming the buy-back request into a buy-back order.

Upon receipt of the buy-back request acceptance (block 539 and decision block 541, exit branch Y), the order fulfillment evaluation unit 230 in turn confirms the order to the retailer 115h fulfilled (block 548). The order confirmation is received by the retailer 115h (block 545). The wholesaler who accepted the buy-back order schedules the delivery of the tires to the retailer 115h (block 549); the ordered tires will thus be delivered to the retailer 115h by the second delivery system 165, e.g. by a small van of the wholesaler 150, for example during one of the frequent deliveries by which the wholesaler services the retailers 160a, . . . , 160k. The wholesaler 150 then issues an invoice to the tires manufacturing company 105 for the bought-back tires (block 551). In turn, the tires manufacturing company 105 invoices the retailer 115h (as it would be should the order be satisfied within the first tire distribution channel).

Thanks to the tires distribution management method and system according to the described embodiment of the present invention, a greater efficiency is achieved. In particular, it is possible to fulfill order from retailers belonging to the first distribution channel availing of the greater flexibility of the second distribution channel.

Everything is accomplished in a way essentially transparent to the retailers of the first tires distribution channel the only difference experienced by them being who delivers the ordered tires thereto.

Although the present invention has been disclosed and described by way of some embodiments, it is apparent to those skilled in the art that several modifications to the described embodiments, as well as other embodiments of the present invention are possible without departing from the spirit or essential features thereof/the scope thereof as defined in the appended claims.

For example, the order fulfillment evaluation unit 230 in the data processing system of the call center may not be provided for, and the check of the tire availability and delivery time constraint compliance be performed by a call-center operator.

Also, even though described making reference to the distribution of tires, the goods distribution method and system according to the present invention is applicable to the distribution of goods which are very different in nature, and is particularly useful in the distribution of goods which are relatively bulky.

1-11. (canceled)

12. A goods distribution management system for managing distribution of goods to a plurality of retailers, comprising:
a first goods distribution channel for distributing the goods to a first group of retailers;
a second goods distribution channel for distributing the goods to a second group of retailers distinct from the retailers of the first group, wherein the second distribution channel comprises at least one wholesaler having a goods storage comprising goods purchased from a goods manufacturer and distributing the purchased goods to the second group of retailers; and
a first data processing system adapted to manage the distribution of goods in the first distribution channel, said first data processing system being adapted to manage orders of goods received from the retailers of the first group, wherein said first data processing system comprises:
a first storage inquiry unit adapted to assess an availability of ordered goods and a goods delivery schedule of the first distribution channel;
a second storage inquiry unit adapted to assess an availability of the ordered goods in the goods storage of the at least one wholesaler; and
a buy-back request placement unit operatively associated with the first and second storage inquiry units and adapted to place a buy-back request to the at least one wholesaler for buying-back the ordered goods, said buy-back request, if accepted by the wholesaler, causing the wholesaler to schedule a delivery of bought-back goods to the retailer of the first group.

13. The goods distribution management system according to claim 12, wherein said first storage inquiry unit is adapted to determine an expected delivery date for the ordered goods based on a goods delivery schedule of the first goods distribution channel.

14. The goods distribution management system according to claim 12, further comprising:
a second data processing system in the at least one wholesaler, said second data processing system being in data communication relationship with the first data processing system,
wherein the second data processing system comprises a buy-back request receipt and processing unit adapted to receive and process buy-back requests from the buy-back request placement unit of the first data processing system.

15. The goods distribution management system according to claim 14, wherein said second data processing system comprises a wholesaler database containing data indicative of the goods storage of the wholesaler.

16. The goods distribution management system according to claim 15, wherein the second data processing system comprises a wholesaler goods storage inquiry unit operatively associated with the wholesaler database and the second storage inquiry unit and adapted to assess the availability of the ordered goods in the goods storage of the wholesaler and to provide information about the assessed availability to the second order fulfillment capability assessing unit.

17. The goods distribution management system according to claim 15, wherein said first data processing system comprises a local copy of the wholesaler database, said second storage inquiry unit being adapted to assess the availability of the ordered goods in the goods storage of the at least one wholesaler by inquiring the local copy of the wholesaler database.

18. The goods distribution management system according to claim 12, wherein said goods comprise vehicle tires.

19. A goods distribution management method for managing the distribution of goods to a plurality of retailers, comprising:
providing a first goods distribution channel for distributing the goods to a first group of retailers;
providing a second goods distribution channel for distributing the goods to a second group of retailers distinct from the retailers of the first group, wherein the second distribution channel comprises at least one wholesaler having a goods storage comprising goods purchased from a goods manufacturer and distributing the purchased goods to the second group of retailers;
receiving an order of goods from a retailer belonging to the first group of retailers, the order of goods comprising a delivery time constraint;
assessing an availability of ordered goods and a goods delivery schedule of the first distribution channel, and
in case the ordered goods are not available and/or the goods delivery schedule does not comply with the delivery time constraint:
retrieving information about wholesaler goods storage; and
assessing an availability of the ordered goods in the wholesaler goods storage; and
in case of positive assessment of availability, placing a buy-back request to the at least one wholesaler for buying-back the ordered goods, wherein in case the buy-back request is accepted by the wholesaler, the wholesaler schedules delivery of bought-back goods to the retailer of the first group.

20. The goods distribution management method according to claim 19, wherein said assessing the goods delivery schedule of the first distribution channel comprises determining an expected delivery date for the ordered goods based on a goods delivery schedule of the first goods distribution.

21. The method according to claim 19, wherein said assessing an availability of the ordered goods in the wholesaler goods storage comprise accessing a database containing data indicative of the goods storage of the wholesaler.

22. The goods distribution management method according to claim 19, wherein said goods comprises vehicle tires.
